(19) United States
(12) Patent Application Publication
(10) Pub. No.: US 2012/0154528 A1
(43) Pub. Date: Jun. 21, 2012

(54) Image Processing Device, Image Processing Method and Image Display Apparatus

(76) Inventors: Ryo Hidaka, Tokyo (JP); Akihiro Oue, Tokyo (JP)

(21) Appl. No.: 13/174,218

(22) Filed: Jun. 30, 2011

(30) Foreign Application Priority Data
Dec. 20, 2010 (JP) 2010-283513

(51) Int. Cl. H04N 5/14; H04N 13/00

(52) U.S. Cl. 348/43; 348/699; 348/E05.062; 348/E13.003

(57) ABSTRACT

According to one embodiment, an image processing device includes a motion detector and a depth generator. The motion detector is configured to detect a motion vector of a video signal. The depth generator is a depth generating means configured to generate depth data of the video signal based on the motion vector. The depth generator is configured to generate the depth data when the video signal is a still image.

### CROSS REFERENCE TO RELATED APPLICATIONS

This application is based upon and claims the benefit of priority from the prior Japanese Patent Application No. 2010-283513, filed on Dec. 20, 2010, the entire contents of which are incorporated herein by reference.

### FIELD

Embodiments described herein relate generally to an image processing device, an image processing method and an image display apparatus.

### BACKGROUND

Recently, a stereoscopic display apparatus has been widely used. A plurality of parallax images seen from different viewpoints are displayed on the stereoscopic display apparatus. An image is seen as a stereoscopic image by seeing one parallax image from the left eye and seeing another parallax image from the right eye. The parallax images may be generated based on depth data of each pixel in the video signal. However, when the video signal does not have the depth data, the depth data has to be generated by analyzing the video signal. Conventionally proposed manners cannot always generate the depth data with high accuracy.

### BRIEF DESCRIPTION OF THE DRAWINGS

FIG. 1 is a schematic block diagram of an image display system having an image display apparatus 110 according to one embodiment.

FIG. 2 is a schematic block diagram showing an example of an internal configuration of the parallax image generating device 100.

FIG. 3 is a schematic block diagram showing an example of an internal configuration of the motion detector 3.

FIG. 4 is a flowchart showing an example of processing operation of the motion detector 3.

FIGS. 5A to 5C are diagrams schematically showing a relationship between the video signal, the motion vector and the output of the display 200.

### DETAILED DESCRIPTION

In general, according to one embodiment, an image processing device includes a motion detector and a depth generator. The motion detector is configured to detect a motion vector of a video signal. The depth generator is a depth generating means configured to generate depth data of the video signal based on the motion vector. The depth generator is configured to generate the depth data when the video signal is a still image.

Embodiments will now be explained with reference to the accompanying drawings.

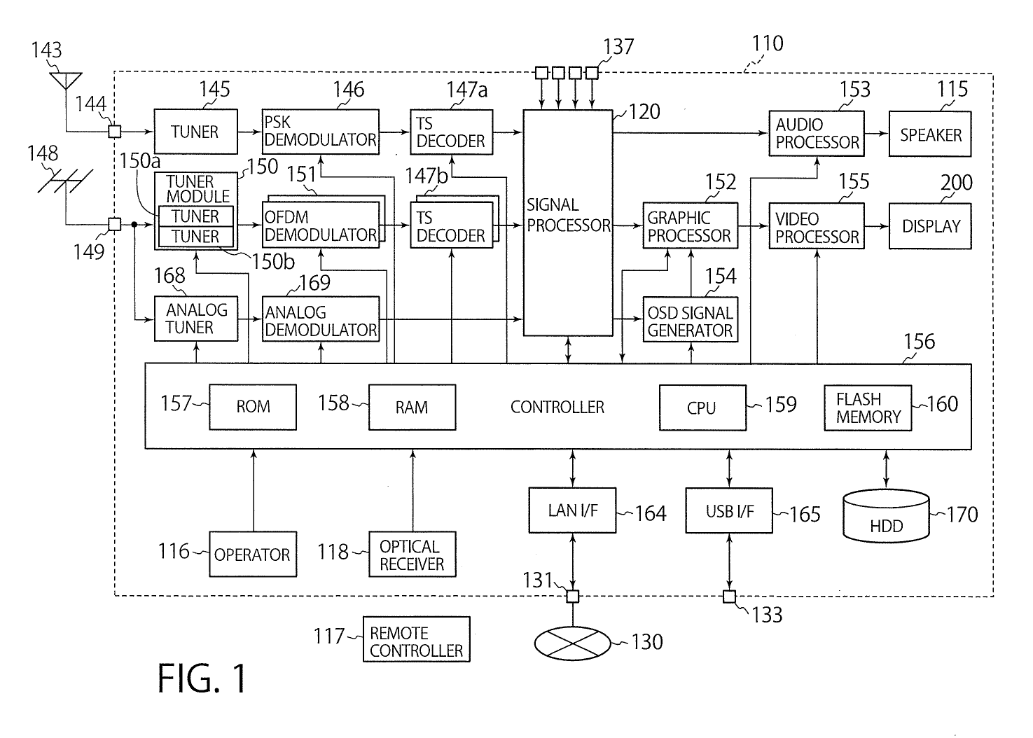

FIG. 1 is a schematic block diagram of an image display system having an image display apparatus 110 according to one embodiment.

The image display apparatus 110 has a controller 156 for controlling operations of each part, an operator 116, an optical receiver 118. The controller 156 has a ROM (Read Only Memory) 157, a RAM (Random Access Memory) 158, a CPU (Central Processing Unit) 159 and a flash memory 160.

The controller 156 activates a system control program and various processing programs stored in the ROM 157 in advance in accordance with an operation signal inputted from the operator 116 or inputted through the optical receiver 118 sent from the remote controller 117. The controller 156 controls the operations of each part according to the activated programs using the RAM 158 as a work memory of the CPU 159. Furthermore, the controller 156 stores and uses information and so on necessary for various settings in the flash memory 160 which is a non-volatile memory such as a NAND flash memory, for example.

The image display apparatus 110 further has an input terminal 144, a tuner 145, a PSK (Phase Shift Keying) demodulator 146, a TS (Transport Stream) decoder 147a and a signal processor 120.

The input terminal 144 sends a satellite digital television broadcasting signal received by an antenna 143 for receiving a BS/CS digital broadcast to the tuner 145 for the satellite digital broadcast. The tuner 145 tunes the received digital broadcasting signal to send the tuned digital broadcasting signal to the PSK demodulator 146. The PSK demodulator 146 demodulates the TS from the digital broadcasting signal to send the demodulated TS to the TS decoder 147a. The TS decoder 147a decodes the TS to a digital signal including a digital video signal, a digital audio signal and a data signal to send it to the signal processor 120.

Here, the digital video signal is a digital signal relating to a video which the image display apparatus 110 can output. The digital audio signal is a digital signal relating to an audio which the image display apparatus 110 can output. Furthermore, the data signal is a digital signal indicative of various kind of information about demodulated serves.

The image display apparatus 110 further has an input terminal 149, a tuner module having two tuners 150a and 150b, two OFDM (Orthogonal Frequency Division Multiplexing) demodulators 151, two TS decoders 147b, an analog tuner 168 and an analog demodulator 169.

The input terminal 149 sends a terrestrial digital television broadcasting signal received by an antenna 148 for receiving the terrestrial digital broadcast to the tuner 150 for the terrestrial digital broadcast. The tuners 150a and 150b in the tuner module 150 tune the received digital broadcasting signal to send the tuned digital broadcasting signal to the two OFDM demodulators 151, respectively. The OFDM demodulators 151 demodulate the TS from the digital broadcasting signal to send the demodulated TS to the corresponding TS decoder 147b. The TS decoder 147b decodes the TS to a digital video signal and a digital audio signal and so on to send them to the signal processor 120. The terrestrial digital television broadcast obtained by each of the tuners 150a and 150b in the tuner module 150 are decoded to the digital video signal, the digital audio signal and the digital signal including the data signal simultaneously by the two OFDM demodulators 151 and the TS decoders 147b, and then, can be sent to the signal processor 120.

The antenna 148 can also receive a terrestrial analog television broadcasting signal. The received terrestrial analog television broadcasting signal is divided by a divider (not shown) and sent to the analog tuner 168. The analog tuner 168 tunes the received analog broadcasting signal and sends the tuned analog broadcasting signal to the analog demodulator 169. The analog demodulator 169 demodulates the analog broadcasting signal to send the demodulated analog broadcasting signal to the signal processor 120. Furthermore, the image display apparatus 110 can display CATV (Common Antenna Television) by connecting a tuner for the CATV to the input terminal 149 connected to the antenna 148, for example.

The image display apparatus 110 further has a line input terminal 137, an audio processor 153, a speaker 115, a graphic processor 152, an OSD (On Screen Display) signal generator 154, a video processor 155 and a display 220.

The signal processor 120 performs a suitable signal processing on the digital signal sent from the TS decoders 147a and 147b or from the controller 156. More specifically, the signal processor 120 divides the digital signal into the digital video signal, the digital audio signal and the data signal. The digital video signal is sent to the graphic processor 152, and the divided digital audio signal is sent to the audio processor 153. Furthermore, the signal processor 120 converts the broadcasting signal sent from the analog demodulator 169 to a video signal and an audio signal in a predetermined digital format. The converted digital video signal is sent to the graphic processor 152, and the converted digital audio signal is sent to the audio processor 153. Furthermore, the signal processor 120 performs a digital signal processing on an input signal from the line input terminal 137.

The audio processor 153 converts the inputted audio signal to an analog audio signal in a format capable of being reproduced by the speaker 115. The analog audio signal is sent to the speaker 115 and is reproduced.

The OSD signal generator 154 generates an OSD signal for displaying an UI (User Interface) window or the like in accordance with a control of the controller 156. Furthermore, the data signal divided by the signal processor 120 from the digital broadcasting signal is converted to the OSD signal in a suitable format and is sent to the graphic processor 152.

The graphic processor 152 decodes the digital video signal sent from the signal processor 120. The decoded video signal is combined with the OSD signal sent from the OSD signal generator 154 and is sent to the video processor 155. The graphic processor 152 can send the decoded video signal or the OSD signal selectively to the video processor 155.

Furthermore, the graphic processor 152 generates a plurality of parallax images seen from different viewpoints (images having parallax therebetween), which will be described below in detail.

The video processor 155 converts the signal sent from the graphic processor 152 to an analog video signal in a format the display 200 can display. The analog video signal is sent to the display 200 to be displayed. The display 200 is, for example, a crystal liquid display having a size of “12” inch or “20” inch.

The image display apparatus 110 further has a LAN (Local Area Network) terminal 131, a LAN I/F (Interface) 164, a USB (Universal Serial Bus) terminal 133, a USB I/F 165 and a HDD (Hard Disk Drive) 170.

The LAN terminal 131 is connected to the controller 156 through the LAN I/F 164. The LAN terminal 131 is used as a general LAN-corresponding port using an Ethernet (registered trademark). In the present embodiment, a LAN cable is connected to the LAN terminal 131, and it is possible to communicate with an internet 130.

The USB terminal 133 is connected to the controller 156 through the USB I/F 165. The USB terminal 133 is used as a general USB-corresponding port. For example, a cellular phone, a digital camera, a card reader/writer for various memory cards, a HDD and a key board or the like can be connected to the USB terminal 133 through a hub. The controller 156 can communicate with devices connected through the USB terminal 133.

The HDD 170 is a magnetic storage medium in the image display apparatus 110, and has a function for storing various information of the image display apparatus 110.

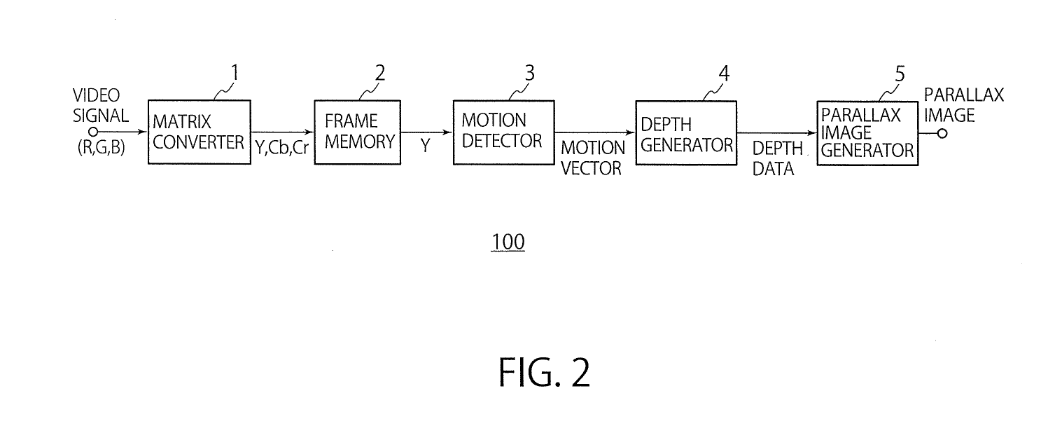

Next, a parallax image generating device 100, which is one of the characteristic features of the present embodiment, will be explained. FIG. 2 is a schematic block diagram showing an example of an internal configuration of the parallax image generating device 100. The parallax image generating device 100 generates depth data by analyzing a video signal and generates a plurality of parallax images based on the generated depth data. The parallax image generating device 100 is, for example, formed on a semiconductor chip and integrated in the graphic processor 152.

The parallax image generating device 100 has a matrix converter 1, a frame memory 2, a motion detector 3, a depth generator 4 and a parallax image generator 5. These parts are controlled by executing a program stored in the EEPROM (Electrically Erasable Programmable ROM) (not shown).

The matrix converter 1 converts a digital video signal (hereinafter, referred to as “video signal”) in a RGB format using a predetermined matrix coefficients to a video signal in a YCbCr (luminance and color differences) format. Note that, when the video signal is originally inputted in the YCbCr format, this processing is not needed. The video signal in the YCbCr format is sent to the frame memory 2. The frame memory 2 stores the video signal in the YCbCr format by a unit of a frame.

The motion detector 3 reads-out the luminance Y from the frame memory 2 and determines whether the video signal is a still image. Then, the motion detector 3 generates a motion vector of each block (rectangle area having a plurality of pixels (for example, 4*4 pixels) in the frame) based on the determination result. The generated motion vector is sent to the depth generator 4. Thus, in the present embodiment, the motion vector is generated based on the determination result of whether or not the video signal is a still image. The motion detector 3 will be explained in detail below.

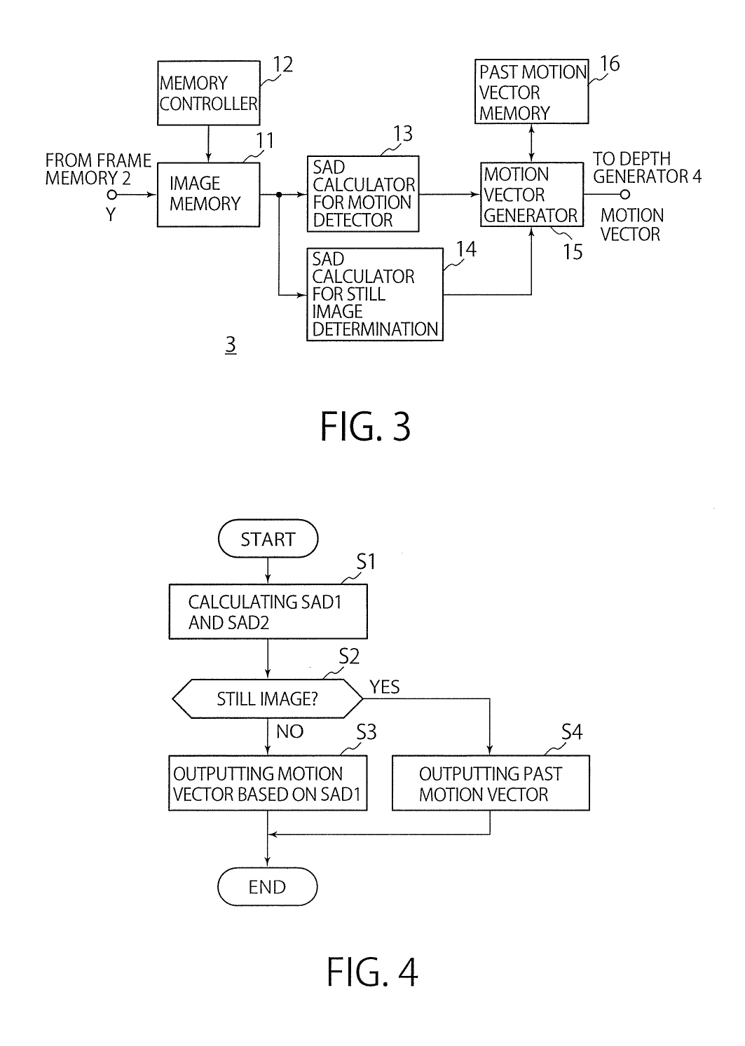

FIG. 3 is a schematic block diagram showing an example of an internal configuration of the motion detector 3. The motion detector 3 has an image memory 11, a memory controller 12, an SAD (Sum of Absolute Differences) calculator 13 for motion detection, an SAD calculator 14 for still image determination, a motion vector generator 15 and a past motion vector memory 16.

The image memory 11 stores the luminance Y of the present frame and the past frame (for example, passing “1” frame) outputted from the frame memory 2 of FIG. 2. Writing and reading out of the image memory 11 is controlled by the memory controller 12.

The memory controller 12 performs block matching between the present frame and the past frame to generate a “temporal” motion vector. More specifically, a sum of absolute differences SAD1 is calculated by accumulating absolute differences of the luminance Y between each of the pixels in a target block for motion detection in the present frame and each of the pixels in the block in the past frame. Then, the motion vector corresponding to a block having a smallest sum of absolute differences SAD1 is outputted to the motion vector generator 15 as the “temporal” motion vector of the target block of the motion detection. The “temporal” motion vector is generated for each of the blocks in the present frame.

If the video signal is the still image, the present frame is similar to the past frame. Therefore, the sum of absolute differences SAD1 between the target block of the motion detection in the present frame and the block in the past fame whose position corresponds to the target block becomes smallest. As a result, the motion vector becomes “0”.

The SAD calculator 14 for still image determination determines whether or not the video signal is the still image by comparing the present frame and the past frame. More specifically, a sum of absolute differences SAD2 is calculated by accumulating absolute differences of the luminance Y in whole of the frame between each of the pixels in the present frame and each of the corresponding pixels in the past frame. Then, when the sum of absolute differences SAD2 is smaller than a predetermined threshold, the video signal is determined to be the still image. That is, although the video signal is not strictly the still image, the video signal is considered to be the still image when the difference between the present frame and the past frame is small.

The motion vector generator 15 generates the motion vector based on the determination result of the still image and outputs the generated motion vector to the depth generator 4 of FIG. 2. Furthermore, the past motion vector memory 16 stores the generated motion vector. More specifically, when the video signal is not determined to be the still image, the “temporal” motion vector outputted from the SAD calculator 13 for motion detection is used as the motion vector. On the other hand, when the video signal is determined to be the still image, the past motion vector stored in the past motion vector memory 16 is used as the motion vector.

When the video signal is the still image, the motion vector becomes “0” vector as described above. However, the motion vector generator 15 can output the past motion vector also in this case.

FIG. 4 is a flowchart showing an example of processing operation of the motion detector 3. Firstly, the SAD calculator 13 for motion detection and the SAD calculator 14 for still image determination calculate the sums of absolute differences SAD1 and SAD2, respectively (Step 51). Secondly, the SAD calculator 14 for still image determination compares the sum of absolute differences SAD2 with the predetermined threshold to determine whether the video signal is the still image (Step S2). When the video signal is not determined to be the still image (Step S2—NO), the motion vector generator 15 outputs the motion vector generated by the SAD calculator 13 for motion detection based on the sum of absolute differences SAD1 (Step S3). On the other hand, when the video signal is determined to be the still image (Step S2—YES), the motion vector generator 15 outputs the past motion vector stored in the past motion vector memory 16 (Step S4).

Based on the generated motion vector, the depth generator 4 of FIG. 2 generates the depth data. For example, the depth generator 4 generates the depth data taking the motion vector into consideration, that is, as the motion vector of the block is larger, the depth data is generated so that the block exists at nearer-side of the display 200, while as the motion vector of the block is smaller, the depth data is generated so that the block exists at farther-side of the display 200. The depth data can be reshaped by performing a time filtering processing and/or a spatial filtering processing. The depth data includes information indicative of which the depth of each pixel is near-side or far-side and how long the depth is.

The parallax image generator 5 generates the plurality of parallax images of the video signal using the generated depth data. For example, in a case of the parallax image seen from a left side, if a first object exists in front of a second object, the first object is seen at right side of the second object. Therefore, the parallax image generator 5 performs a processing for shifting the first object to the right side. As the depth data is larger, the shift amount is set larger. Then, the position where the first object is located is properly interpolated by surrounding pixels. The parallax images for a left eye and a right eye may be generated for stereoscopic display using glasses, or nine parallax images may be generated for autostereoscopic display without glasses, for example.

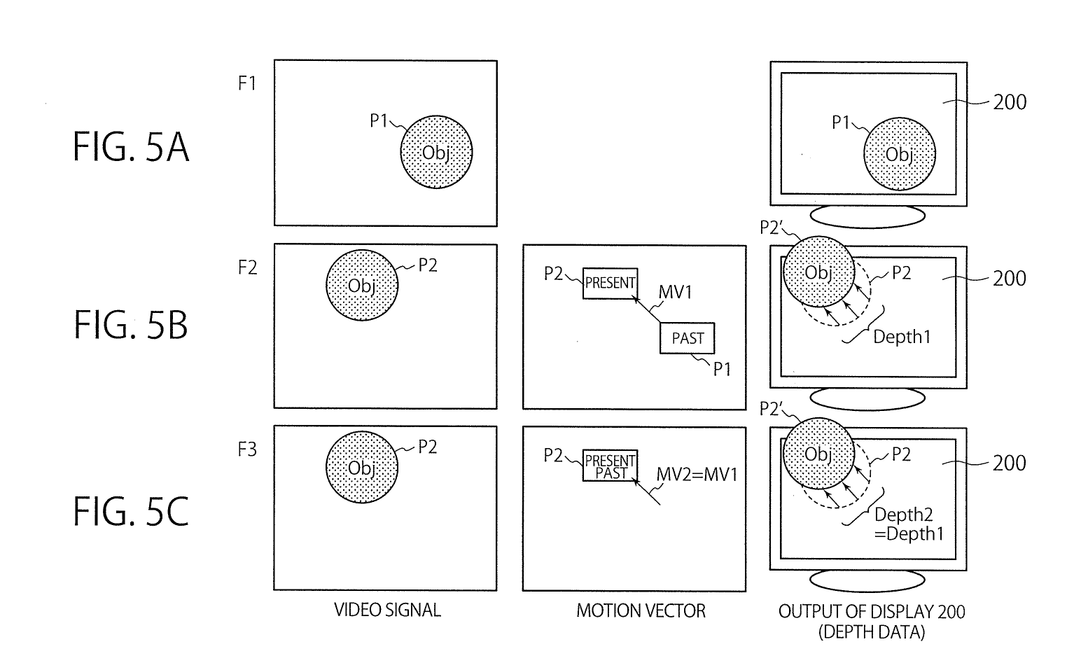

FIGS. 5A to 5C are diagrams schematically showing a relationship between the video signal, the motion vector and the output of the display 200.

FIG. 5A shows the video signal and the output of the display 200 at the first frame Fl. In the frame Fl, an object OBJ is located at a position P1, and the object OBJ is displayed on the display 200 at the corresponding position P1.

FIG. 5B shows the video signal, the motion vector and the output of the display 200 at the second frame F2 after the frame F1. It is assumed that the object OBJ moves to a position P2 at the frame F2. Then, because the video signal is not the still image, the motion detector 3 generates the motion vector MV1 heading from the position P1 at the past frame Fl to the position P2 at the present frame F2. Based on the motion vector MV1, the depth generator 4 generates the depth data Depth1 of FIG. 5B. As a result, as shown in FIG. 5B, the object OBJ is displayed so that the object OBJ is seen at a position P2′ which is near-side of the display 200. Note that the motion vector MV1 is stored in the past motion vector memory 16.

FIG. 5C shows the video signal, the motion vector and the output of the display 200 at the third frame F3 after the frame F2. It is assumed that the object OBJ stays at position P2 at the frames F2 and F3. Then, because the video signal is the still image, the motion detector 3 outputs the motion vector MV1 stored in the past motion vector memory 16 as the motion vector MV2 of the frame F3. Therefore, the depth data Depth1 equal to the depth data Depth1 is generated. As a result, as shown in FIG. 5C, the object OBJ is again displayed so that the object OBJ is seen at near-side of the display 200.

If the still image determination is not performed, the motion vector becomes “0” vector at the frame F3, and the depth data becomes a value indicating that the object OBJ is not stereoscopically displayed. As a result, the object OBJ is not stereoscopically displayed at the frame F3 and displayed at the position P2 on the display 200. Although the object OBJ stays from the frame F2 to the frame F3, the seen position or the depth vary, which may cause an unnatural display.

On the other hand, in the present embodiment, because the motion vector is generated by performing the still image determination, the object OBJ at frame F3 is displayed at a position same as that at the frame F2.

As stated above, in the present embodiment, the SAD calculator 13 for motion detection and the SAD calculator 14 for still image determination are provided in the motion detector 3. The still image determination is performed based on the sum of absolute differences calculated by the SAD calculator 14 for still image determination. When the image is not determined to be the still image, the motion vector is generated based on the sum of absolute differences calculated by the SAD calculator 13 for motion detection, while when the video image is determined to be the still image, the past generated motion vector is outputted. Therefore, even if the video signal is the still image, the motion vector suitable to stereoscopic display is generated, thereby generating the depth data for stereoscopically displaying the video signal with high accuracy.

Note that, in the still image determination, it is possible to determine whether or not whole of the frame is the still image, or determine whether or not a unit smaller than the whole of the frame, such as the block or the object in the frame is the still image. Furthermore, the motion detector 3 of FIG. 3 can use a scale-downed image for the motion detection or the still image determination. Because of this, the circuit volume and the operation amount can be decreased. In this case, the sums of absolute differences can be calculated by a scale-downed pixel.

Although an example is shown where the parallax image generating device in integrated on the image display apparatus in the above mentioned embodiment, the image processing device can be composed by integrating the parallax image generating device on a broadcast receiver such as a STB (Set Top Box) or a reproduction device of a recording media and so on.

At least a part of the image processing device explained in the above embodiments can be formed of hardware or software. When the image processing device is partially formed of the software, it is possible to store a program implementing at least a partial function of the image processing device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the image processing device can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An image processing device comprising:
a motion detector configured to detect a motion vector of a video signal; and
a depth generator which is a depth generating means configured to generate depth data of the video signal based on the motion vector, the depth generator being configured to generate the depth data when the video signal is a still image.

2. The device of claim 1, wherein the depth generator is configured to set a motion vector generated in past time as the motion vector of the video signal when the video signal is the still image.

3. The device of claim 2, wherein the motion detector comprises a memory configured to store the generated motion vector, and
the motion detector is configured to set the motion vector stored in the memory as the motion vector of the video signal when the video signal is the still image.

4. The device of claim 1 further comprising a parallax image generator configured to generate a plurality of parallax images for stereoscopically displaying the video signal,
wherein the depth generator is configured to generate the depth data in such a manner that the video signal is stereoscopically displayed when the video signal is the still image.

5. The device of claim 1, wherein the motion detector is configured to determine whether the video signal is the still image by comparing a present frame in the video signal and a past frame inputted before the present frame.

6. An image display apparatus comprising:
a motion detector configured to detect a motion vector of a video signal;
a depth generator which is a depth generating means configured to generate depth data of the video signal based on the motion vector, the depth generator being configured to generate the depth data when the video signal is a still image;
a parallax image generator configured to generate a plurality of parallax images for stereoscopically displaying the video signal; and
a display configured to display the plurality of parallax images.

7. The apparatus of claim 6, wherein the depth generator is configured to set a motion vector generated in past time as the motion vector of the video signal when the video signal is the still image.

8. The apparatus of claim 7, wherein the motion detector comprises a memory configured to store the generated motion vector, and
the motion detector is configured to set the motion vector stored in the memory as the motion vector of the video signal when the video signal is the still image.

9. The apparatus of claim 6, wherein the depth generator is configured to generate the depth data in such a manner that the video signal is stereoscopically displayed when the video signal is the still image.

10. The apparatus of claim 6, wherein the motion detector is configured to determine whether the video signal is the still image by comparing a present frame in the video signal and a past frame inputted before the present frame.

11. An image processing method comprising:
generating a motion vector of a video signal; and
generating depth data of the video signal based on the motion vector, the depth data being generated when the video signal is the still image.

12. The method of claim 11, wherein upon generating the depth data, a motion vector generated in past time is used as the motion vector of the video signal when the video signal is the still image.

13. The method of claim 11 further comprising generating a plurality of parallax images for stereoscopically displaying the video signal,
wherein upon generating the depth data, the depth data is generated in such a manner that the video signal is stereoscopically displayed when the video signal is the still image.

14. The method of claim 11, wherein upon generating the depth data, whether the video signal is the still image is determined by comparing a present frame in the video signal and a past frame inputted before the present frame.
